(19) United States
(12) Patent Application Publication
(10) Pub. No.: US 2017/0083078 A1
(43) Pub. Date: Mar. 23, 2017

(54) HIGH DEFINITION MULTIMEDIA INTERFACE POWER MANAGEMENT

(71) Applicant: Intel Corporation, Santa Clara, CA (US)

(72) Inventors: Satish Prathaban, Bangalore (IN); Ramaswamy Parthasarathy, Bangalore (IN); Prakash K. Radhakrishnan, Portland, OR (US)

(73) Assignee: Intel Corporation, Santa Clara, CA (US)

(21) Appl. No.: 15/234,142

(22) Filed: Aug. 11, 2016

(30) Foreign Application Priority Data
Sep. 23, 2015 (IN) 5073/CHENP/2015

(51) Int. Cl. G06F 1/32; G06F 13/40; G06F 11/30; G06F 13/42

(52) U.S. Cl. CPC G06F 1/3287; G06F 13/4282; G06F 13/4022; G06F 11/3041

(57) ABSTRACT

An apparatus for managing HDMI power is described herein. The method for managing HDMI power can include connecting a high definition multimedia interface (HDMI) of a computing device to a panel, where the computing device is inactive. The method can also include detecting, with the panel, a connection state and an energy request of the computing device through the HDMI. The method can provide power through the HDMI from a power supply of the panel to the computing device based on the connection state and the energy request of the computing device. The method can activate the computing device.

### CROSS REFERENCE TO RELATED APPLICATION

The present application claims the benefit of the filing date of India Patent Application No. 5073/CHENP/2015, filed Sep. 23, 2015, which is incorporated herein by reference.

### TECHNICAL FIELD

The present techniques relate generally to transmission of power. More specifically, the present techniques relate to methods of managing the transmission of power using a high definition multimedia interface (HDMI).

### BACKGROUND ART

HDMI is a proprietary audio/video interface for transferring uncompressed video data and compressed or uncompressed digital audio data from an HDMI-compliant source computing device. The computing device can connect and transmit the video/audio data to a number of to the panel of a number of HDMI devices including a computer monitor, a video projector, a digital television, a digital audio device, and other HDMI compatible signal data receivers.

### BRIEF DESCRIPTION OF THE DRAWINGS

FIG. 1A is a block diagram of an example system on chip (SoC) on a printed circuit board (PCB) for power transmission with HDMI;

FIG. 1B is a schematic diagram of a simplified example of an apparatus for receiving power from a panel through an HDMI;

FIG. 2 is a block diagram of an example panel for providing power to system on a chip;

FIG. 3 is a process flow diagram describing an example method for power management during HDMI connection;

FIG. 4 is a process flow diagram describing an example method for power management during an HDMI disconnection;

FIG. 5 is a block diagram showing tangible, non-transitory computer-readable media that stores code for power transmission with an HDMI; and

FIG. 6 is a process flow diagram describing an example method for power management and detection through an HDMI.

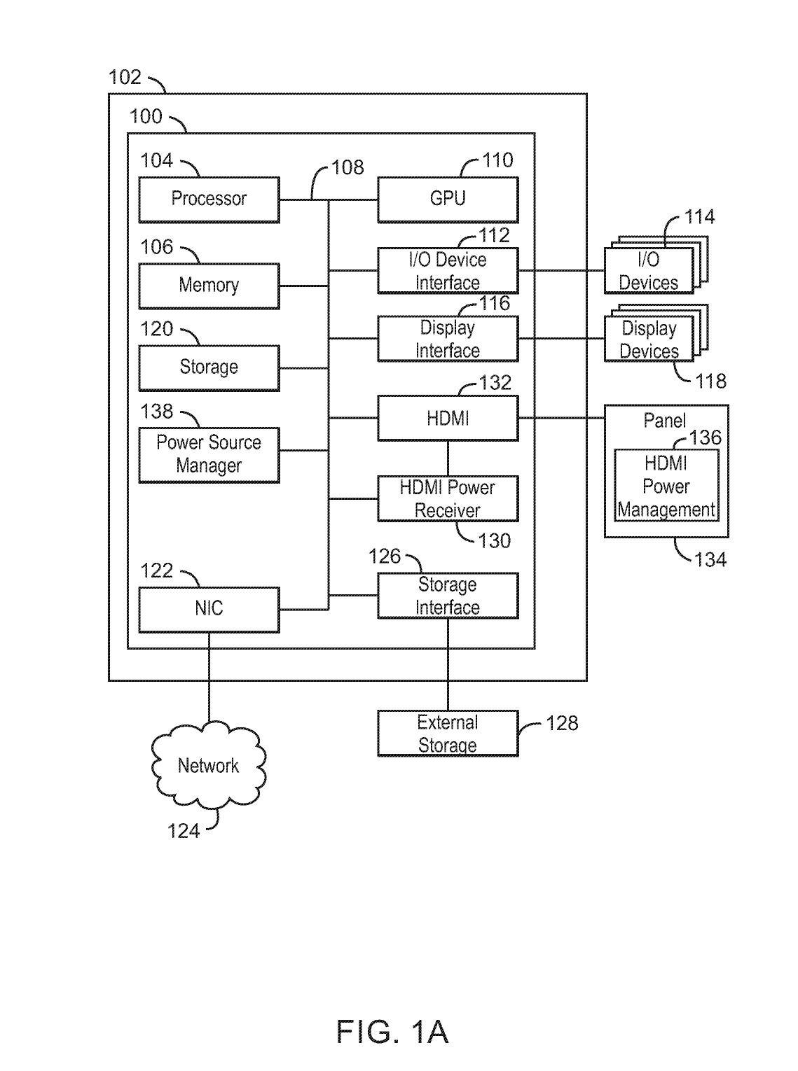

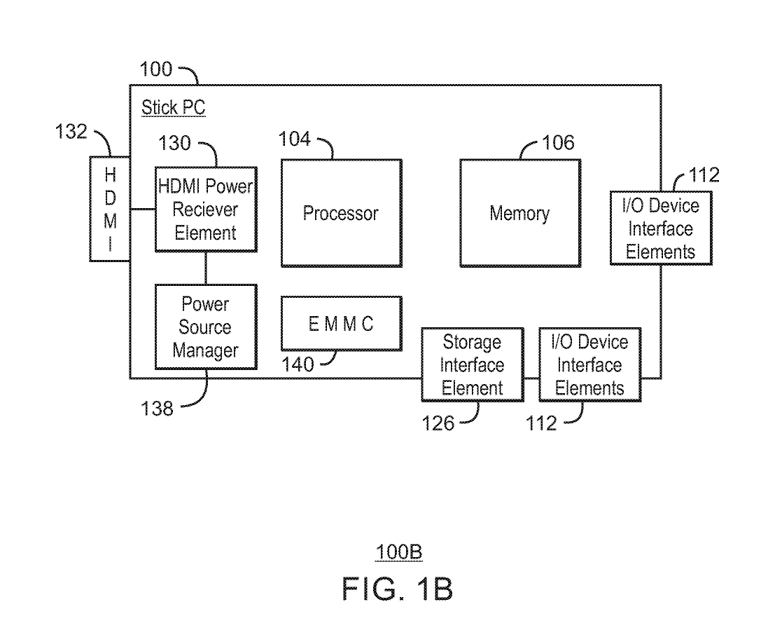

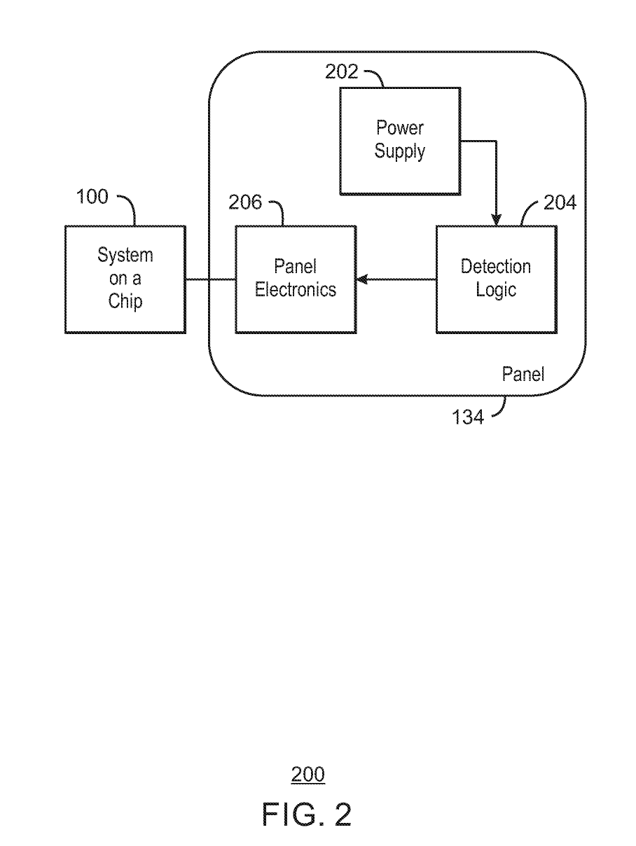

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Power for computing devices, including mobile phones and tablets can be provided by a separate power line or with an adaptor. Techniques disclosed herein include management and providing of power to a computing device, such as an HDMI compliant source device, through HDMI. The techniques disclosed herein allow the use of a single HDMI connection rather than the use of adaptors and multiple lines for power and signal to a display device. Further, in an example, the present techniques allow the display and transmission of video/audio data through the HDMI rather than through a Display Port of the computing device to a Display port of a display device.

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It can be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SoC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus′, methods, and systems described herein are not limited to physical computing devices, but may also relate to software optimizations for energy conservation and efficiency. As can become readily apparent in the description below, the embodiments of methods, apparatus', and systems described herein (whether in reference to hardware, firmware, software, or a combination thereof) are vital to a ‘green technology’ future balanced with performance considerations.

FIG. 1A is a block diagram of an example system on chip (SoC) 100 on a printed circuit board (PCB) for power transmission with HDMI. The SoC 100 and PCB 102 may be components of, for example, a computing device such as a laptop computer, desktop computer, Ultrabook, tablet computer, mobile device, mobile phone, or server, among others. The SoC 100 may include a central processing unit (CPU) 104 that is configured to execute stored instructions, as well as a memory device 106 that stores instructions that are executable by the CPU 104. The CPU may be coupled to the memory device 106 by a bus 108. Additionally, the CPU 104 can be a single core processor, a multi-core processor, a computing cluster, or any number of other configurations. Furthermore, the SoC 100 may include more than one CPU 104.

The SoC 100 may also include a graphics processing unit (GPU) 110. As shown, the CPU 104 may be coupled through the bus 108 to the GPU 110. The GPU 110 may be configured to perform any number of graphics functions and actions. For example, the GPU 110 may be configured to render or manipulate graphics images, graphics frames, videos, or the like, to be displayed to a user of the SoC 100. The memory device 106 can include random access memory (RAM), read only memory (ROM), flash memory, or any other suitable memory systems. For example, the memory device 106 may include dynamic random access memory (DRAM).

The CPU 104 may be connected through the bus 108 to an input/output (I/O) device interface 112 configured to connect with one or more I/O devices 114. The I/O devices 114 may include, for example, a keyboard and a pointing device, wherein the pointing device may include a touchpad or a touchscreen, among others. The I/O devices 114 may be built-in components of a platform including the SoC 100, or may be devices that are externally connected to a platform including the SoC 100. In embodiments, the I/O devices 114 may be a keyboard or a pointing device that is coupled with the I/O device interface 112.

In an example, the I/O device interfaces 112 can include a connection to the SoC 100 through a Mobile High-Definition Link (MHL) interface. While the I/O devices 114 can connect through an MHL interface to the I/O device, the present techniques disclosed allow the replacement of the adaptor for this standard with a means for transmitting both signal and power over an HDMI interface. In some examples, an MHL interface can provide 40 W of power with the appropriate conversion adaptor to interface with a SoC 100. In an example, an I/O device interface 112 can include a connection to the SoC 100 through a Type-C universal serial bus (USB). As discussed above, the presently disclosed techniques allow the transmitting of signal and power through means other than the Type-C interface, however, the HDMI techniques and the Type-C interface and connection can both co-exist as connections to the SoC 100. In an example, a Type-C interface can allow additional inputs to a computing device or SoC 100. In an example the operating voltage needed to fully power the resources of a SoC 100 can include or exceed 15-25 W, while some I/O device interfaces 112 may be unable to provide this amount of power without additional connections or adaptors.

The CPU 104 may also be linked through the bus 108 to a display interface 116 configured to connect with one or more display devices 118. The display devices 118 may include a display screen that is a built-in component of a platform including the SoC 100. Examples of such a computing device include mobile computing devices, such as cell phones, tablets, 2-in-1 computers, notebook computers or the like. The display device 118 may also include a computer monitor, television, or projector, among others, that is externally connected to the SoC 100. In embodiments, the display devices 118 may be a DisplayPort device that is coupled with the display interface 116.

The SoC 100 may also be coupled with a storage device 120. The storage device may be a component located on the PCB 102. Additionally, the storage device 120 can be a physical memory such as a hard drive, an optical drive, a thumb drive, an array of drives, or any combinations thereof. The storage device 120 may also include remote storage drives. The SoC 100 may also include a network interface controller (NIC) 122 may be configured to connect the SoC 100 through the bus 108, various layers of the PCB 102, and components of the PCB 102 to a network 124. The network 124 may be a wide area network (WAN), local area network (LAN), or the Internet, among others.

The SoC 100 can also be coupled to a storage interface 126 configured to connect to at least one external storage 128. The storage interface 126 can include an interface for secure digital cards, external hard drives, external flash drives, or other types of external data storage devices that can act as external storage 128.

The SoC 100 can also be coupled to an HDMI power receiver 130 to receive power incoming though a High Definition Multimedia Interface (HDMI) 132 from a panel 134. In an example, the HDMI power receiver 130 can include a power store such as a battery. In an example, if the HDMI power receiver 130 includes a power store, this power store may be used to transmit a signal, such as an electrical signal through the HDMI 132 to the panel 134 to wake the panel, if the panel 134 is inactive. The HDMI 132 follows the HDMI specification and can be connected to a panel 134 in order to transmit video and audio data. The HDMI 130 can receive power from a panel 134 over pins in the HDMI. The Panel 134 can include HDMI power management 136 to manage the activation of circuitry in the panel 134 to transmit power to the SoC 100 through the HDMI 132. The panel 134 can be a panel 134 of a display device 118, and can also be a separate device able to receive and use video and audio data. The HDMI power management 134 can modify the voltage and current a panel 134 transmits to an HDMI interface. HDMI power management 136 can modify voltage using a Direct Current to Direct Current (DC-to-DC) converter, in an example a DC-to-DC converter located on the panel 134. The control of HDMI power management can include a direct current (DC) power switch to turn off circuitry the HDMI power management 136 detects a disconnection of an HDMI 132 connected SoC 100.

The SoC 100 can also be coupled to a power source manager 138 to manage power on and incoming to the SoC 100. As discussed above, power from the panel 134 can be used to provide power to the SoC 100. In examples, the power provided can co-exist with other potential power sources like battery's located on the SoC 100 or provided from an external power source connected through an I/O Device Interface 112 such as a USB Type C interface. The power source manager 138 can manage the power supply to the SoC 100 based on the presence of the power sources and power supplies and if these power sources are able to supply and operating voltage either individually or combined. The power source manager 138 can regulate which power source supplies what amount of power to the SoC 100 and can also detect if a power source is disconnected to manage a transition to a second or third power source. The power source manager 138 can include logic to manage the power depending on where it comes from and can include the ability to decide priority from power sources.

It is to be understood that the block diagram of FIG. 1 is not intended to indicate that the SoC 100 is to include all of the components shown in FIG. 1. Rather, the SoC 100 can include fewer or additional components not illustrated in FIG. 1. Furthermore, the components may be coupled to one another according to any suitable system architecture, including the system architecture shown in FIG. 1 or any other suitable system architecture that uses a data bus to facilitate communications between components. For example, embodiments of the present techniques can also be implemented any suitable electronic device, including ultra-compact form factor devices, such as SoC and multi-chip modules.

FIG. 1B is a schematic diagram of a simplified example of an apparatus for receiving power from a panel through an HDMI. Like numbered items are as described in FIG. 1A.

The apparatus shown can include the SoC 100 of FIG. 1, and can be any other computing device of the same function. Power can be received at a number of locations including through the HDMI 132 and through an I/O interface 112 as discussed above. Although power lines are shown connecting the HDMI 132 to a HDMI power receiver 130 to a power source manager 138, these connections are exemplary and any configuration of connections suitable for powering and communicating between elements and items shown in FIG. 1B are also included. For example, power from HDMI can be used to power the entire platform including the processor 104 and all elements shown. As discussed above, a power source manager 138 can also manage the power received from multiple sources including the HDMI 132 and an I/O interface element 112 such as a USB Type C interface.

The SoC 100 shown can include a multimedia card such as an embedded multimedia card (EMMC) 140 can include a memory and a controller to store instructions for a processor 104. The instructions stored on an EMMC 140 can include the instruction to send a signal through the HDMI 132 to wake a device that is inactive. The signal can be sent when the EMMC 140 detects connection to a device through the HDMI 132, where the device is initially inactive upon connection. The EMMC 140 can also include instructions that can detect when a device connected through an HDMI 132 is active. When an active device is connected through the HDMI 132, the EMMC 140 can either initiate or respond to a request to provide power to the SoC 100 through the HDMI 132. In an example, the connected device may be unable to provide sufficient power to operate the SoC, i.e. reach an operational voltage, however, the processor 104 can execute instructions to allow the SoC 100 to draw parts of the power it needs from multiple sources to reach an operational voltage.

In an example, the power can be provided through an HDMI from an HDMI monitor or TV to enable a large monitor with SoC 100 or computing device to connected for a PC for PC experience. In some examples, the HDMI monitors and TVs can provide 5V through a convertor for USB based operation, however, the present techniques allow the modification of the power output to allow, for example, 25 W through the HDMI.

In an example, the HDMI specification has included that a wake up event can be provided by the device connected to the panel, sometimes referred to as the slave, to signal using an electrical or power signal to wake the panel from an inactive mode. The inactive mode can include a shut-down mode, a hibernation mode, an sleep mode, or other similar inactive states. In an example, the power signal from the SoC 100 can power and initiate the wake, or awakening, or powering of the panel. As discussed below in FIGS. 2, 3, and 5, the example panel, upon wake, can provide power, including an operational voltage, to the SoC 100 through the HDMI 132.

FIG. 2 is a block diagram 200 of an example panel 136 for providing power to system on a chip 100. Like numbered items are as describe in FIG. 1. FIG. 2 can show a SoC 100 such as an Intel Core/Atom based Stick PC connecting to an HDMI port of a TV or the TV panel 134 to effectively convert the TV into a display so that all together the system can function as a computer and TV-sized display.

The panel 134 can include a power source 202. The power supply 202 can be a storage such as a battery and can also be power from AC mains and other similar sources. As discussed above, the panel 134 can instruct, or be instructed, that the power supply 202 is to provide power to a computing device such as a SoC 100 through an HDMI 132. In an example, the instruction for this power to be supplied can be detected by a detection logic 204. The detection logic 204 can include the detection of a received instruction at the panel 136 to provide power through the HDMI. The detection logic 204 can detect a wake signal from a connected device when the panel 134 is inactive, as discussed above.

The detection logic can detect a connection state and an energy request of a computing device such as the SoC 100. The connection state indicates whether or not a computing device, such as the SoC 100 can receive voltage through an HDMI 132 through a physical connection using the pins, contact, or other suitable connection allowing electrical current to flow from the HDMI port of the panel 134. The energy request can include a voltage that the SoC 100 lacks from an operational voltage. Depending on the function an SoC 100 is performing, or the electrical demands of the processes and hardware of the SoC 100, additional voltage can be supplied by the panel 134 based on the energy request detected by the detection logic to meet the energy request of the SoC 100. In an example, the energy request could be for the entire operational voltage for the SoC 100. In an example, the detection logic 204 can detect HDMI compliant computing device insertion. The computing device can have a small power to enable this logic, when the panel and the detection logic 204 are inactive. In an example, the computing device can provide a small power to wake up the panel 134 from sleep.

The panel 134 can include panel electronics 206 to modify the voltage provided to the SoC 100. In an example the panel electronics 206 can include a DC-to-DC converter. The panel electronics 206 can also include a DC switch to shut off the proving of power if the detection logic 204 detects a connection state of “disconnected.” The panel electronics 206 with a DC-to-DC convertor can modify a USB 5V supply available on panel to provide the 5V power to the SoC 100 without a separate cable to power the SoC 100. In an example, the power can be transmitted through pins on the HDMI connector. Using panel electronics 206, the voltage delivered to a computing device like the SoC 100 can also be increased to 12V and 20V or other voltage values based on the DC-DC converter, the power supply, and the panel electronics 206.

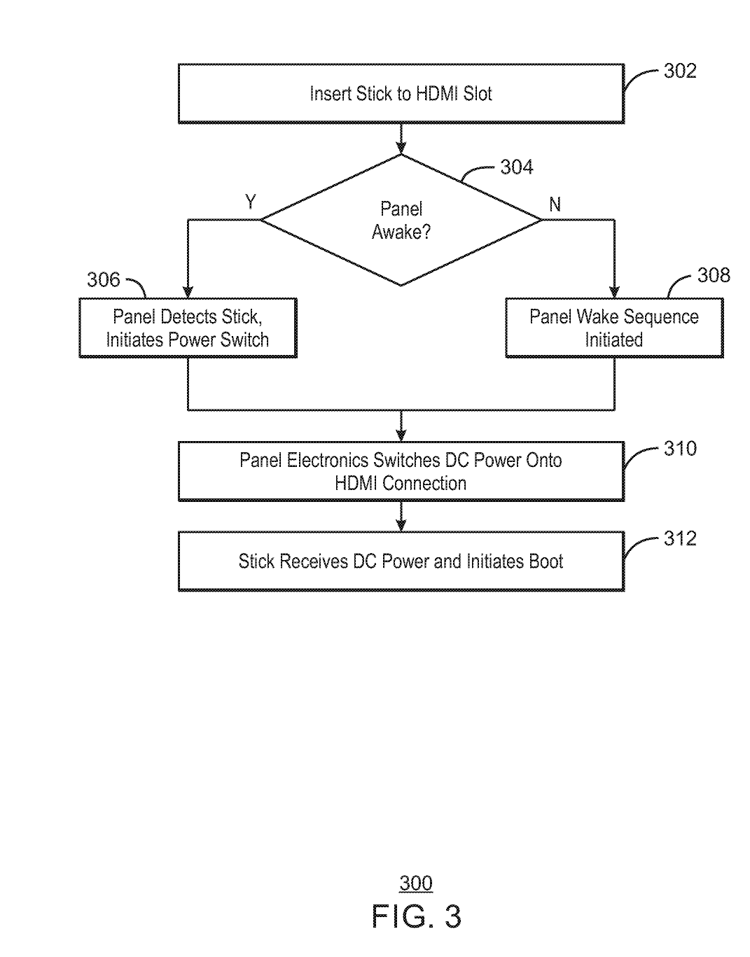

FIG. 3 is a process flow diagram describing an example method for power management during HDMI connection. Process flow begins at block 302.

At block 302, a computing device such as a SoC 100 or Stick can be inserted into an HDMI slot of a panel 134. Inserting the Stick to the HDMI slot can enable a physical and electrical connection between the Stick and the panel 134.

At block 304, the Stick determines if the panel 134 is active or inactive. If the panel is awake, process flow proceeds to block 306. If the panel is inactive process flow proceeds to block 308.

At block 306, the panel 134 is already awake and can detect, using detection logic 204 or HDMI power management 136, the Stick. In an example, the detection can also include detection of a connection state and an energy request. Process flow continues at lock 310.

At block 308, the panel 134 is inactive, and can be woken, with a panel wake sequence. A panel wake sequence can include a computing device such as a SoC 100 or Stick providing a signal including, in an example, an amount of power sufficient to initiate the panel 134 to detect the connection of the stick inserted in the HDMI slot. The providing of an amount of power to the panel 134 can be sufficient to power the panel 134 until a power source 202 of the power becomes active and powers the panel 134. Process flow proceeds to block 310.

At block 310, panel electronics can switch on to power an HDMI connection and the connected computing device, SoC 100, or Stick. In an example the voltage can be 5V of DC. In an example, the voltage can pass through a DC-to-DC converter to modify the voltage provided through the HDMI connection to the computing device in order to meet a detected energy request.

At block 312, the computing device, such as the SoC 100 or Stick can receive the power and initiate additional hardware features, additional software features, or a system boot. In an example the Stick can receive 5V of power. In an example, the Stick can receive a modified voltage based on the energy request of the Stick. FIG. 3 shows, in part, a power up event. The technique disclosed herein allows scalable power supply and can increase the robust handling of SoC 100, personal computers, and Stick that can come in different capabilities and power demands. In an example, the demands of a SoC 100 or Stick can range from 5 W to 30 W may not function with the present HDMI connector's current carrying capabilities. If using present HDMI current carrying capacity, the maximum power from a panel may be hard limited by the power supply. Using the present techniques disclosed, scalability in hardware and power supply can be achieved though enabling higher voltage to be provided through the HDMI 132 from the panel 134. In an example, the HDMI can be modified to carry 20V for higher power demanding connected hardware and can carry 5V for low power hardware or applications. As discussed above, these power thresholds can be detected by the SoC 100 or Stick and the power received can either be modified and managed by the power source manager 138 or the applications and hardware of the SoC 100 can be programmed to operate in lower voltage conditions depending on the power supply available either through the HDMI 132 or a combination of power sources including the HDMI 132. The SoC 100 can receive many forms of Direct Current (DC), including through an HDMI 132, and can manage the power supply and voltage received accordingly.

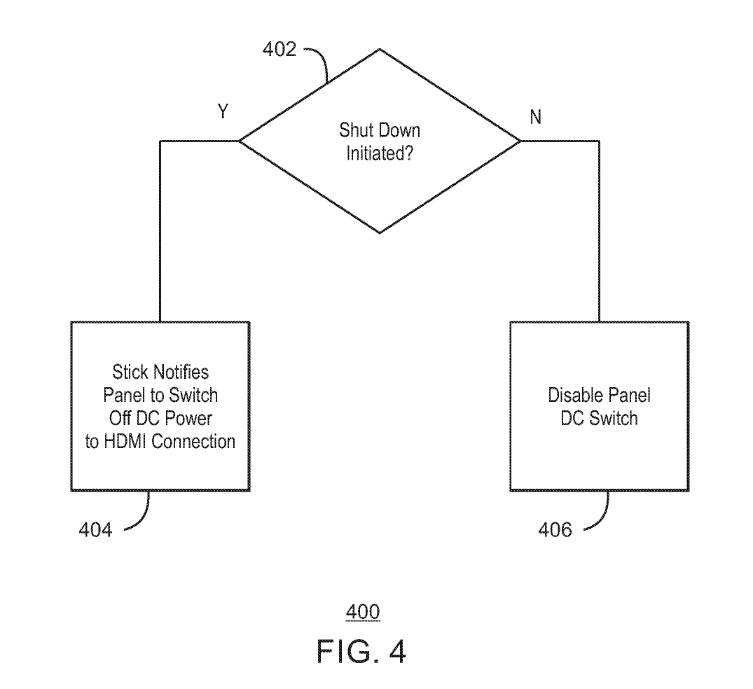

FIG. 4 is a process flow diagram describing an example method for power management during an HDMI disconnection. FIG. 4 shows, in part, a turning off event. Process flow for disconnection of a SoC 100 can begin at block 402.

At block 402, a panel 134 can detect if a shutdown has been initiated. A shutdown can be initiated by a shutdown request made by a user at a SoC 100, or other computing device such as a stick personal computer over an HDMI 132. If yes, a shutdown has been initiated process flow continues at block 404. If no, a shutdown has not been initiated, but a computing device such as a SoC 100 still disconnects process flow continues at block 406.

At block 404, a computing device, SoC 100 such as a stick personal computer (PC) or “Stick” notifies the panel 134 to switch off power through the HDMI 134. The panel 134 can switch off direct current (DC) power to the HDMI connection or can alter the amount of voltage sent through modification with the DC-to-DC converter.

At block 406, the computing device, or SoC 100 is disconnecting the HDMI connection, but a shutdown was not initiated. The disconnection and breaking of an HDMI connection to a device can be detected with detection logic 204 operating as or within HDMI power management 136 of the panel 134. Upon detection of the disconnection. The panel 134 can switch off DC power by disabling a DC switch in the panel electronics 206.

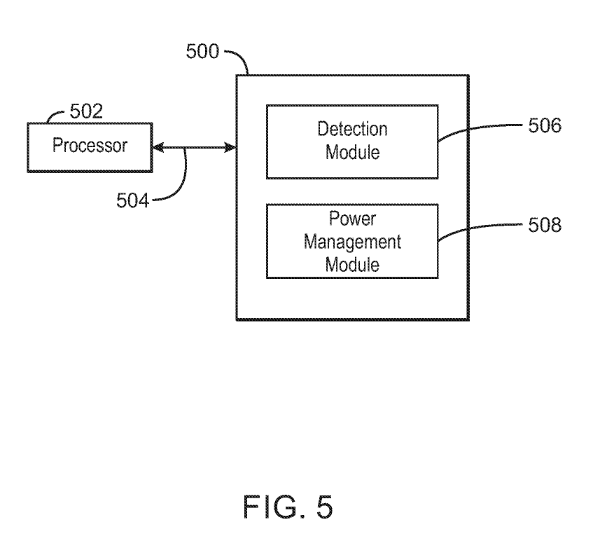

FIG. 5 is a block diagram showing tangible, non-transitory computer-readable media that stores code for power transmission with an HDMI. The tangible, non-transitory computer-readable media 500 may be accessed by a processor 502 over a computer bus 504. Furthermore, the tangible, non-transitory computer-readable medium 500 may include code configured to direct the processor 502 to perform the methods described herein.

The tangible, non-transitory computer-readable media 500 can include a detection module 506, to be embodied at least partly in hardware or circuitry, and to include instructions including detection logic 204 to instruct a processor 502. In an example, the detection module 506 can detect a connection state and an energy need of the computer-readable medium 500 to another device though a connected port.

The tangible, non-transitory computer-readable media 500 can include a HDMI power manager module 508, to be embodied at least partly in hardware or circuitry, and to include instructions including HDMI power management 136 to instruct a processor 502. In an example, the HDMI power manager module 508 can provide power through the HDMI from a power supply 202 of the computer-readable medium 500 to a computing device based on the detected connection state and the energy request of a connected computing device.

The various software components discussed herein may be stored on one or more tangible, non-transitory computer-readable media 500, as indicated in FIG. 5. For example, a detection module 506 can detect, with the panel, a connection state and an energy request of a computing device through the HDMI. A HDMI power management module 508 can provide power through the HDMI from a power supply of the panel to the computing device based on the connection state and the energy request of the computing device.

The block diagram of FIG. 5 is not intended to indicate that the tangible, non-transitory computer-readable media 500 is to include all of the components shown in FIG. 5. Further, the tangible, non-transitory computer-readable media 500 may include any number of additional components not shown in FIG. 5, depending on the details of the specific implementation.

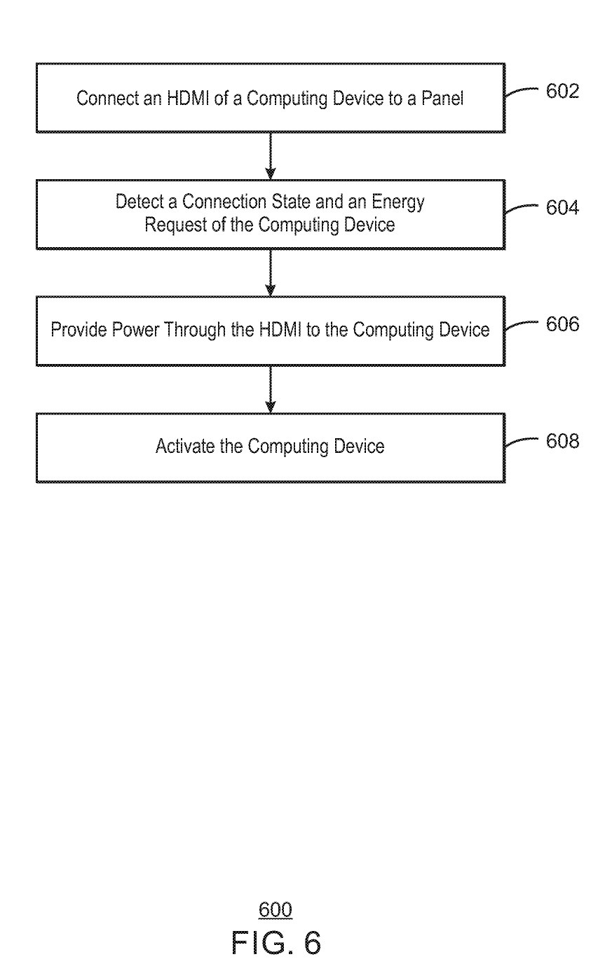

FIG. 6 is a process flow diagram describing an example method for power management and detection though an HDMI. Like numbered items are as described above. Process flow beings a block 602.

At block 602, the HDMI of a computing device is connected to a panel where the computing device is inactive. When a computing device is in active it can be asleep, hibernating, completely unpowered, shutdown, or any other mode that is not fully powered or functioning.

At block 604, the panel can detect a connection state and an energy request of the computing device through the HDMI 132. The panel 134 can detect the connection state through detection logic 204 and can be sent an energy request from the computing device. In an example, if no energy request is sent, the panel 134 can provide an operational voltage or a set energy based on the capabilities of the panel 134. In an example a default of voltage can be 5V.

At block 604, a power supply of the panel can provide power through the HDMI to the computing device based on the connection state and the energy request of the computing device. The providing of the power can be through the pins of the HDMI 132 of the computing device to the pins inside the HDMI port of the panel 134.

At block 606, the computing device is activated. The activating of the computing device can include the activation of additional hardware, software, or the general initializing and booting of the computing device. In an example this method can remove any power cable connection to a computing device, SoC 100, or Stick PC. In an example, the panel 134 can provide a computing device to 25 W of power on HDMI to enable additional functionality without additional cables or adaptors.

### Examples

Example 1 is a method for managing HDMI power. The method includes connecting a high definition multimedia interface (HDMI) of a computing device to a panel, wherein the computing device is inactive; detecting, with the panel, a connection state and an energy request of the computing device through the HDMI; providing power through the HDMI from a power supply of the panel to the computing device based on the connection state and the energy request of the computing device; and activating the computing device.

Example 2 includes the method of example 1, including or excluding optional features. In this example, the method includes waking the panel with a signal from the computing device, if the panel is inactive, to enable the panel to detect and provide power. Optionally, the signal is an electrical signal generated from a power store in the computing device.

Example 3 includes the method of any one of examples 1 to 2, including or excluding optional features. In this example, the power provided from the power supply of the panel is modified using a Direct Current to Direct Current converter.

Example 4 includes the method of any one of examples 1 to 3, including or excluding optional features. In this example, the activating the computing device when the computing device receives an operational voltage from the power supply of the panel through the HDMI.

Example 5 includes the method of any one of examples 1 to 4, including or excluding optional features. In this example, the method includes switching off the power provided through the HDMI from the power supply if the computing device sends and the panel receives a shutdown notification.

Example 6 includes the method of any one of examples 1 to 5, including or excluding optional features. In this example, the method includes switching off a panel direct current switch if the panel detects an updated connection state of the computing device indicating the computing device is no longer connected to the panel through the HDMI.

Example 7 includes the method of any one of examples 1 to 6, including or excluding optional features. In this example, the computing device receives power from the power source of the panel through the HDMI at an HDMI power receiver.

Example 8 includes the method of any one of examples 1 to 7, including or excluding optional features. In this example, the method includes receiving, by the computing device, a portion of an operational voltage from an input/output device. Optionally, the input/output device is connected to the computing device by a Type-C universal serial bus (USB).

Example 9 is a system for HDMI power management. The system includes an high definition multimedia interface (HDMI) of a computing device that is inactive, the HDMI to connect to a panel; a detector of the panel to detect a connection state and an energy request of the computing device through the HDMI; and a power supply of the panel to provide power to the computing device through the HDMI based on the connection state and the energy request of the computing device to allow the computing device to activate.

Example 10 includes the system of example 9, including or excluding optional features. In this example, the panel can be awoken from an inactive state with a signal from the computing device. Optionally, the signal is an electrical signal generated from a power store in the computing device.

Example 11 includes the system of any one of examples 9 to 10, including or excluding optional features. In this example, the power provided from the power supply of the panel is modified using a Direct Current to Direct Current converter located on the panel.

Example 12 includes the system of any one of examples 9 to 11, including or excluding optional features. In this example, the computing device activates when the computing device receives an operational voltage from the power supply of the panel through the HDMI.

Example 13 includes the system of any one of examples 9 to 12, including or excluding optional features. In this example, the panel switches off the power provided through the HDMI if the computing device sends and the panel receives a shutdown notification.

Example 14 includes the system of any one of examples 9 to 13, including or excluding optional features. In this example, the panel switches off a direct current switch of the panel if the panel detects the computing device is no longer connected to the panel through the HDMI.

Example 15 includes the system of any one of examples 9 to 14, including or excluding optional features. In this example, the computing device receives power from the power source of the panel through the HDMI at an HDMI power receiver.

Example 16 includes the system of any one of examples 9 to 15, including or excluding optional features. In this example, computing device receives a portion of an operational voltage from an input/output device. Optionally, the input/output device is connected to the computing device by a Type-C universal serial bus (USB).

Example 17 is an apparatus for HDMI power management. The apparatus includes a processor; a storage to provide instructions to the processor; an high definition multimedia interface (HDMI) to connect the processor to an HDMI receiver; a power store, managed by instructions executed on the processor, to provide a signal over a connection circuit of the HDMI; and a power receiver to receive power from the HDMI and provide the power to the power store and the processor.

Example 18 includes the apparatus of example 17, including or excluding optional features. In this example, the signal sent is to indicate that a device that receives the signal should become active if that device is in an inactive state. Optionally, the signal is an electrical signal generated from a power store in the processor.

Example 19 includes the apparatus of any one of examples 17 to 18, including or excluding optional features. In this example, the power provided from the power supply of the processor is modified using a Direct Current to Direct Current converter located on the processor.

Example 20 includes the apparatus of any one of examples 17 to 19, including or excluding optional features. In this example, the processor activates when the processor receives an operational voltage through the HDMI.

Example 21 includes the apparatus of any one of examples 17 to 20, including or excluding optional features. In this example, the processor sends a shutdown notification.

Example 22 includes the apparatus of any one of examples 17 to 21, including or excluding optional features. In this example, the processor is powered by second power source.

Example 23 includes the apparatus of any one of examples 17 to 22, including or excluding optional features. In this example, the processor receives power through the HDMI at an HDMI power receiver.

Example 24 includes the apparatus of any one of examples 17 to 23, including or excluding optional features. In this example, processor receives a portion of an operational voltage from an input/output device interface. Optionally, the input/output device interface is a Type-C universal serial bus (USB) interface.

Example 25 is a tangible, non-transitory, computer-readable medium. The computer-readable medium includes instructions that direct the processor to connect a high definition multimedia interface (HDMI) of a computing device to a panel, wherein the computing device is inactive; detect, with the panel, a connection state and an energy request of the computing device through the HDMI; provide power through the HDMI from a power supply of the panel to the computing device based on the connection state and the energy request of the computing device; and activate the computing device.

Example 26 includes the computer-readable medium of example 25, including or excluding optional features. In this example, the computer-readable medium includes instructions that, when executed by a processor, direct the processor to wake the panel with a signal from the computing device, if the panel is inactive, to enable the panel to detect and provide power. Optionally, the signal is an electrical signal generated from a power store in the computing device.

Example 27 includes the computer-readable medium of any one of examples 25 to 26, including or excluding optional features. In this example, the power provided from the power supply of the panel is modified using a Direct Current to Direct Current converter.

Example 28 includes the computer-readable medium of any one of examples 25 to 27, including or excluding optional features. In this example, the activating the computing device when the computing device receives an operational voltage from the power supply of the panel through the HDMI.

Example 29 includes the computer-readable medium of any one of examples 25 to 28, including or excluding optional features. In this example, the computer-readable medium includes instructions that, when executed by a processor, direct the processor to switch off the power provided through the HDMI from the power supply if the computing device sends and the panel receives a shutdown notification.

Example 30 includes the computer-readable medium of any one of examples 25 to 29, including or excluding optional features. In this example, the computer-readable medium includes instructions that, when executed by a processor, direct the processor to switch off a panel direct current switch if the panel detects an updated connection state of the computing device indicating the computing device is no longer connected to the panel through the HDMI.

Example 31 includes the computer-readable medium of any one of examples 25 to 30, including or excluding optional features. In this example, the computing device receives power from the power source of the panel through the HDMI at an HDMI power receiver.

Example 32 includes the computer-readable medium of any one of examples 25 to 31, including or excluding optional features. In this example, the computer-readable medium includes instructions that, when executed by a processor, direct the processor to receive, by the computing device, a portion of an operational voltage from an input/output device. Optionally, the input/output device is connected to the computing device by a Type-C universal serial bus (USB).

Example 33 is a system for HDMI power management. The system includes instructions that direct the processor to an high definition multimedia interface (HDMI) of a computing device that is inactive, the HDMI to connect to a panel; means to detect a connection state and an energy request of the computing device through the HDMI; and means to provide power to the computing device through the HDMI based on the connection state and the energy request of the computing device to allow the computing device to activate.

Example 34 includes the system of example 33, including or excluding optional features. In this example, the panel can be awoken from an inactive state with a signal from the computing device. Optionally, the signal is an electrical signal generated from a power store in the computing device.

Example 35 includes the system of any one of examples 33 to 34, including or excluding optional features. In this example, the power provided from the means to provide power to the computing device through the HDMI is modified using a Direct Current to Direct Current converter located on the panel.

Example 36 includes the system of any one of examples 33 to 35, including or excluding optional features. In this example, the computing device activates when the computing device receives an operational voltage from the means to provide power to the computing device through the HDMI.

Example 37 includes the system of any one of examples 33 to 36, including or excluding optional features. In this example, the panel switches off the power provided through the HDMI if the computing device sends and the panel receives a shutdown notification.

Example 38 includes the system of any one of examples 33 to 37, including or excluding optional features. In this example, the panel switches off a direct current switch of the panel if the panel detects the computing device is no longer connected to the panel through the HDMI.

Example 39 includes the system of any one of examples 33 to 38, including or excluding optional features. In this example, the computing device receives power from the power source of the panel through the HDMI at an HDMI power receiver.

Example 40 includes the system of any one of examples 33 to 39, including or excluding optional features. In this example, computing device receives a portion of an operational voltage from an input/output device. Optionally, the input/output device is connected to the computing device by a Type-C universal serial bus (USB).

While the present techniques have been described with respect to a limited number of embodiments, those skilled in the art can appreciate numerous modifications and variations therefrom. It is intended that the appended claims cover all such modifications and variations as fall within the true spirit and scope of this present techniques.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the present techniques may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

In the foregoing specification, a detailed description has been given with reference to specific exemplary embodiments. It can, however, be evident that various modifications and changes may be made thereto without departing from the broader spirit and scope of the present techniques as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. A method for managing HDMI power, comprising,
connecting a high definition multimedia interface (HDMI) of a computing device to a panel, wherein the computing device is inactive;
detecting, with the panel, a connection state and an energy request of the computing device through the HDMI;
providing power through the HDMI from a power supply of the panel to the computing device based on the connection state and the energy request of the computing device; and
activating the computing device.

2. The method of claim 1, comprising waking the panel with a signal from the computing device, if the panel is inactive, to enable the panel to detect and provide power.

3. The method of claim 2, wherein the signal is an electrical signal generated from a power store in the computing device.

4. The method of claim 1, wherein the power provided from the power supply of the panel is modified using a Direct Current to Direct Current converter.

5. The method of claim 1, wherein the activating the computing device when the computing device receives an operational voltage from the power supply of the panel through the HDMI.

6. The method of claim 1, comprising switching off the power provided through the HDMI from the power supply if the computing device sends and the panel receives a shutdown notification.

7. The method of claim 1, comprising switching off a panel direct current switch if the panel detects an updated connection state of the computing device indicating the computing device is no longer connected to the panel through the HDMI.

8. The method of claim 1, wherein the computing device receives power from the power source of the panel through the HDMI at an HDMI power receiver.

9. The method of claim 1, comprising receiving, by the computing device, a portion of an operational voltage from an input/output device.

10. The method of claim 9, wherein the input/output device is connected to the computing device by a Type-C universal serial bus (USB).

11. A system for HDMI power management, comprising:
an high definition multimedia interface (HDMI) of a computing device that is inactive, the HDMI to connect to a panel;
a detector of the panel to detect a connection state and an energy request of the computing device through the HDMI; and
a power supply of the panel to provide power to the computing device through the HDMI based on the connection state and the energy request of the computing device to allow the computing device to activate.

12. The system of claim 11, wherein the panel can be awoken from an inactive state with a signal from the computing device.

13. The system of claim 12, wherein the signal is an electrical signal generated from a power store in the computing device.

14. The system of claim 11, wherein the power provided from the power supply of the panel is modified using a Direct Current to Direct Current converter located on the panel.

15. The system of claim 11, wherein the computing device activates when the computing device receives an operational voltage from the power supply of the panel through the HDMI.

16. The system of claim 11, wherein the panel switches off the power provided through the HDMI if the computing device sends and the panel receives a shutdown notification.

17. The system of claim 11, wherein the panel switches off a direct current switch of the panel if the panel detects the computing device is no longer connected to the panel through the HDMI.

18. The system of claim 11, wherein the computing device receives power from the power source of the panel through the HDMI at an HDMI power receiver.

19. The system of claim 11, wherein computing device receives a portion of an operational voltage from an input/output device.

20. The system of claim 19, wherein the input/output device is connected to the computing device by a Type-C universal serial bus (USB).

21. An apparatus for HDMI power management, comprising:
a processor;
a storage to provide instructions to the processor;
an high definition multimedia interface (HDMI) to connect the processor to an HDMI receiver;
a power store, managed by instructions executed on the processor, to provide a signal over a connection circuit of the HDMI; and
a power receiver to receive power from the HDMI and provide the power to the power store and the processor.

22. The apparatus of claim 21, wherein the signal sent is to indicate that a device that receives the signal should become active if that device is in an inactive state.

23. The apparatus of claim 22, wherein the signal is an electrical signal generated from a power store in the processor.

24. The apparatus of claim 21, wherein the power provided from the power supply of the processor is modified using a Direct Current to Direct Current converter located on the processor.

25. The apparatus of claim 21, wherein the processor activates when the processor receives an operational voltage through the HDMI.
